(19) United States
(12) Patent Application Publication
(10) Pub. No.: US 2008/0163980 A1
(43) Pub. Date: Jul. 10, 2008

(54) Wood-Gluing and Clamping System

(76) Inventor: Adrian Joseph Van de Mosselaer, Kelowna (CA)

Correspondence Address: ADRIAN VAN DE MOSSELAER, 1410 APPLERIDGE RD., KELOWNA, BC, V1W 3A6, omitted

(21) Appl. No.: 11/620,920

(22) Filed: Jan. 8, 2007

(51) Int. Cl. B05C 3/00

(52) U.S. Cl. 156/356

(57) ABSTRACT

A wood gluing and clamping system enabling the continuous production of edge or face glued pieces of lumber or wood products. The system includes a deck, a clamping and downstream pressure system, and a braking system. The edge-gluing system may be used in conjunction with finger-jointing processes or with single pieces of lumber and may be used for the production of structural and non-structural wood products.

### FIELD OF THE INVENTION

The invention relates to a wood gluing and clamping system enabling the continuous production of edge or face glued pieces of lumber or wood products. The system includes a deck, a clamping and downstream pressure system, and a braking system. The edge-gluing system may be used in conjunction with finger-jointing processes or with single pieces of lumber and may be used for the production of structural and non-structural wood products.

### BACKGROUND OF THE INVENTION

In the lumber industry, it is well know that wood boards can be edge-glued to create larger panels of wood or face glued to create beams.

It is also known that shorter pieces of lumber can be finger-jointed and glued end-to-end to produce longer lumber.

As with solid, single piece boards, finger-jointed boards can be utilized as conventional lumber (ie for framing) or can be edge-glued and/or face-glued to create other lumber products. In particular, edge-glued lumber can be used to create slabs and face-glued lumber can be used to create beams.

In the past, individual boards of single-piece or finger-jointed lumber could be further assembled by edge-gluing to create slabs or face-glued to create beams in relatively slower one-at-a-time, batch-type, processes.

For example, past edge-gluing processes apply adhesive to the edges of the adjacent boards and clamp and press adjacent boards together while the adhesive is curing to form a slab. However such processes are generally non-continuous, slow and/or labour intensive which results in higher production coast than could be achieved if the slab was created in a continuous high-speed process.

While other continuous flow-through processes have been developed, they have proven to not be commercially reliable or reliable for structural applications.

For example, past continuous flow-through edge-gluing processes lack the ability to provide certifiable bonding pressures and lack the ability to ensure bonding pressures are maintained at all times, and have proven to lack the ability to operate in a commercial production environment.

Accordingly, there has been a need for an edge or face gluing process and apparatus that provides the commercially reliable continuous assembly of lumber into edge-glued or face-glued slabs at high speed with reliable clamping pressure.

Another problem with past wood-gluing equipment is the clamping pressure profile applied to a growing slab. That is, in the past systems which may apply a clamping pressure across a growing slab, as each successive board is added to the growing slab, there are substantial changes in the clamping pressure as linear shuttle advance and retreat. Additionally, systems that have been developed in an attempt to resolve this issue do not have the ability to reliably maintain measurable high inter-joint pressures required for certifiable bonding. Accordingly, there has been a need for a wood-gluing process and apparatus which provides a high, reliable, measurable, continuous clamping pressure across the width of the slab while additional boards are being prepared and added to the slab.

Further still, there is a distinction between panels manufactured for furniture or trim (non-structural) and for construction (structural). In particular, structural lumber requires that the strength of any glued joint is greater than that of the wood, whereas non-structural wood does not require the same joint strength or integrity. In manufacturing structural grade lumber form glued pieces of wood, either finger-joint or edge-glued, in order to ensure certifiable joint strength, measurable and reliable clamping pressures are required for proper adhesive bonding and certification by third party certification agencies.

Past edge-gluing systems have not solved these problems. A review of the prior art has revealed U.S. Pat. No. 6,779,576 (Cable) which discloses a process for edge-bonding in a flow through process; U.S. Pat. No. 6,025,053 and U.S. Pat. No. 5,888,620 (Grenier) which disclose a process for adhesively bonding finger-jointed lengths of wood in side-by-side relationship to form boards; U.S. Pat. No. 4,314,871 (Weinstock) which discloses a method and apparatus for laminating to form laminated beams; U.S. Pat. No. 4,565,597 (Shulte) which discloses a method for producing a veneer web which are bonded side-by-side to form a veneer web; U.S. Pat. No. 5,679,191 (Robinson) which discloses a method and apparatus of fabricating trailer flooring via an edge-gluing process and U.S. Pat. No. 3,927,705 (Cromeens), U.S. Pat. No. 4,128,119 (Maier), U.S. Pat. No. 4,941,521 (Redekop) and U.S. Pat. No. 5,67,910 (Hill) and U.K. Patent 746,135 (Jacquier) which each disclose edge-gluing and finger-jointing apparatus per se.

### SUMMARY OF THE INVENTION

The invention solves the above problems by providing a high-speed clamping system that maintains a measurable consistent and certifiable clamping pressure across a width of a growing slab while exposing the trailing edge of the growing slab for addition of further lamina.

More specifically, and in accordance with the invention, there is provided an apparatus for applying a measurable consistent and certifiable clamping pressure between a plurality of boards comprising:
a) A deck for supporting a plurality of boards, the deck having an upstream end and downstream end;
b) A horizontal displacement system operatively connected to the upstream end for applying a downstream force to the plurality of boards, the horizontal displacement system operable between a disengaged position allowing a new board to be positioned adjacent the upstream end and as engaged position where the plurality of boards is advanced towards the downstream end;
c) A braking system operatively connected to the downstream end for retarding the advancement of the plurality of boards along the deck. The braking force exerted is computer controlled to create the braking resistance required in order for the desired clamping pressure to be maintained.
d) A one-way clamping and downstream pressure system operatively connected to the deck for preventing upstream movement of the plurality of boards, and to provide the downstream force required to maintain the desired clamping pressure when the horizontal displacement system is moved from the engaged position to the disengaged position.

### DESCRIPTION OF THE DRAWINGS

These and other features of the invention are described with reference to the drawings wherein:

FIG. 1 is a schematic side view of a wood clamping system in accordance with one embodiment of the invention.

FIG. 2 is a schematic plan view of the wood clamping system.

FIG. 3 has been deleted

FIG. 4 is a schematic side view of the one-way clamping and downstream pressure system.

FIG. 5 is a graph showing inter-board joint pressure as a function of time.

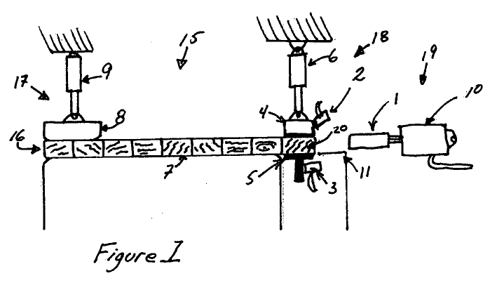

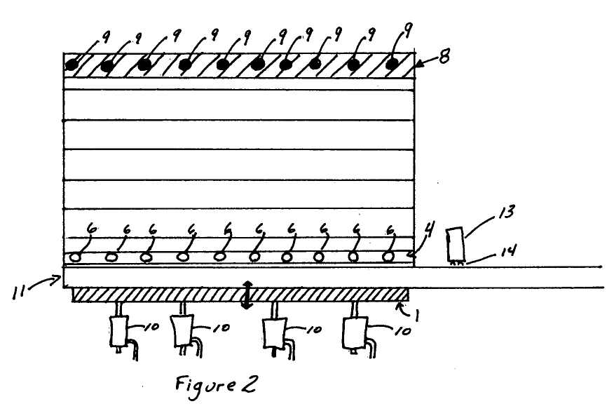

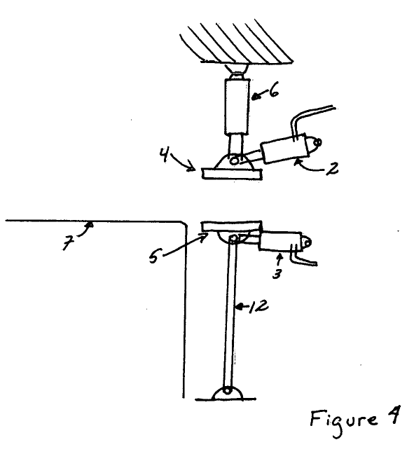

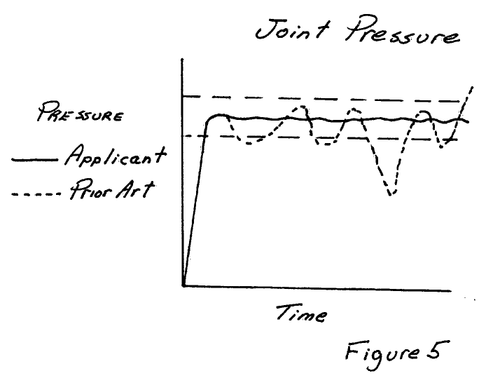

### DETAILED DESCRIPTION OF THE INVENTION

### System Overview

In accordance with the invention and with reference to the figures, a wood gluing and clamping system 15 is described which provides a continuous clamping pressure across a deck 7 of a growing slab or panel of glued lumber 16. The system 15 generally includes a deck 7, a braking system 17, a one-way clamping and downstream pressure system 18, and a horizontal displacement system 19 for forming a panel of edge-glued lumber or a beam of face glued-lumber. The following description is written in the context of an edge-gluing system although it is understood that the system may be used on the same manner for face gluing.

In operation, a slab or panel if edge-glued boards 16 is created by successively shuttling a new board past glue station 13 to the end of deck 11 whereupon the horizontal displacement system (HDS) 19 applies a sideways force to the trailing edge of the board causing it to make contact with the board 20 that is in place within the one-way clamping and downstream pressure system 18. As the new board makes contact with the previously positioned board 20 the HDS meets resistance. When the resistance is electronically calculated to meet the load required for the desired inter-joint pressure, the one-way clamping and downstream pressure system relaxes the downward pressure created by cylinder 6 and braking pad 4, at the same time transfers the pressure on downstream pressure cylinders 3 and 2 to the HDS 19. The braking system 17 relaxes its braking resistance by relieving sufficient pressure from cylinder 9. Just as the higher braking resistance in created by the braking system 17 raises the load resistance for the HDS 19, the braking system 17 can also reduce the load on the HDS 19 by reducing the pressure within braking system cylinder 9. Computer controls allow simultaneous control of each of these systems to ensure that HDS 19 is creating the load needed to generate the inter-joint pressures required for the edge-gluing process.

As the panel 16 is advanced by the width of the incoming board the one-way clamping and downstream pressure system engages the board 20 by applying pressure to cylinder 6 causing braking surfaces 4 and 5 to make positive contact with board 20. Braking system 17 increases pressure to positively secure the slab 16 from being able to make any further downstream progress, and downstream pressure is transferred from HDS 19 to cylinders 2 and 3 which pressurize sufficiently to maintain the load required to create the desired inter-joint pressures as the HDS 19 retreats to a position capable of accepting a new board moving into position.

Importantly, the consistent, calculable and measurable inter-joint pressures are maintain in two ways. Firstly the HDS 19 is capable to generating loads that are far in excess of those required for the inter-joint pressures. As the required load can be calculated and measured within the HDS 19, and as the resistance to the downstream movement of the slab 16 is decreased so is the ability of the of the HDS 19 to generate such a load, it is therefore possible for fluctuation in the braking resistance of the braking system 17 to control the inter-joint pressures created by HDS 19. Secondly, once there is no further downstream movement of slab 16 required, the braking system 17 can firmly hold the slab 16, while the one-way and downstream clamping system engages and provides that downstream load required to generate the desired inter-joint pressures.

### Horizontal Displacement System

The horizontal displacement system 19 includes a board contacting member 1 running the length of the deck 7 and positioned at the upstream end of the deck 11. In most implementations of the system, the board contacting member 1 will typically range in length from 10-62 feet. Horizontal actuation of the board contacting member 1 is realized by a plurality of hydraulic units 10 operatively connected to the board contacting member 1 and to a fixed surface (not shown). The number and spacing of the units 10 is determined by the performance specifications of each hydraulic unit and the desired inter-joint pressures. Appropriate hydraulic control of each hydraulic unit is provided by an appropriate hydraulic control unit (not shown) to provide synchronous actuation of all the hydraulic units. Pressure transducers are used within the hydraulic units to provide the computer controls with the actual pressures being generated by the HDS 19 and the braking system 17.

### Braking System

The braking system 17, as described above, functions to stop the advancement of the panel 16 when the one-way clamping and downstream pressure system 18 is activated or when the HDS 19 is applying pressure below the pressure required to maintain the desired inter-joint pressure. The breaking system 17 retards the advancement of the slab 16 when the HDS 19 required pressure is met.

### One-Way Clamping and Downstream Pressure System

The one-way clamping and downstream pressure system 18 consists of a lower wood contacting surface 5 and an upper wood contacting surface 4. The lower wood contacting surface 5 is pivotally connected to support arm 12 allowing for both upstream and downstream movement of the wood contacting surface 5. The upper wood contacting surface 4 is connected to pressure cylinder 6 which is pivotally connected to an immovable surface allowing upstream and downstream movement of the upper wood contacting surface 4 and cylinder 6.

The upper wood contacting surface 4 is connected to downstream pressure cylinder 2, and the lower wood contacting surface 5 is connected to downstream pressure cylinder 3. Both downstream pressure cylinders provide downstream and upstream movement to the wood contacting surfaces 4 and 5.

Just prior to the full extension of the HDS 19 pushing the slab 16 through the braking system 17, the braking system 17 increases braking breaking pressure causing the slab 16 to cease downstream movement. The load generated by the HDS is reduced to meet the load calculated load required to maintain the desired inter-joint pressure within the slab 16. The pressure cylinder 6 is activated causing both the upper wood contacting surface 4 and lower wood contacting surface 5 to make positive gripping contact with the upper and lower wood surface of slab 16. Downstream pressure is then transferred from the HDS pressure cylinders to the one-way clamping and downstream pressure system 18 downstream pressure cylinders 2 and 3.

With the one-way clamping and downstream pressure system 18 fully engaged and providing the downstream load needed to maintain the required inter-joint pressure within slab 16, the HDS 19 can fully retract and be prepared to accept a new board for inclusion within the slab 16.

Once the new board is in place on table 111 in front of the HDS 19, the HDS extends causing the new board to make contact with board 20. As the load increases within the HDS 19, the downstream pressures are transferred from the one-way clamping and downstream pressure system 18 to the HDS 19.

Once the downstream loads are fully transferred to the HDS 19, the one-way clamping and downstream pressure system 18 fully disengages by pressure cylinder 6 retracting, and downstream pressure cylinder 2 and 3 fully retracting.

### Adhesive Station

The adhesive station 13 is located-adjacent to the board contacting member 1 and includes extruding applicators 14 for applying adhesive to the edge of the incoming new board. The adhesive station 13 has appropriate sensors and control system to apply adhesive only as a new board is advancing across its face, and only as required to create the desired panel with.

### System Deployment

The system may be deployed as a—stand-alone system either in a single-board or finger-joint edge-gluing system or as a fully integrated component of a finger-jointing system.

### System Control

The system can be controlled using programmable logic controllers or computers having timers, pressure, temperature, flow and position sensors as are known in the art.

I claim:

1. An apparatus for applying a consistent clamping pressure between a plurality of boards comprising:
a) a deck for supporting a plurality of boards, the deck having an upstream end and downstream end;
b) a horizontal displacement system operatively connected to the upstream end for applying a downstream force to the plurality of boards, the horizontal displacement system operable between a disengaged position allowing a new board to be positioned adjacent the upstream end and an engaged position where the plurality of boards is advanced towards the downstream end;
c) a braking system operatively connected to the downstream end for retarding advancement of the plurality of boards along the deck when the downstream force is below a threshold pressure and for allowing advancement of the plurality of boards if the downstream force exceeds the threshold pressure, and for stopping the advancement of the plurality of boards as required and,
d) a one-way clamping and downstream pressure system operatively connected to the deck for providing the required downstream pressure when the horizontal displacement system is moving from the engaged position to the disengaged position.

2. A system as in claim 1 wherein the horizontal displacement system includes a horizontal displacement member actuated by at least one hydraulic cylinder.

3. A system as in claim 1 wherein the braking system includes at least one friction plate adjacent the downstream end of the deck, the at least one friction plate for applying a downward pressure.

4. A system as in claim 1 wherein the one-way clamping and downstream pressure system includes at least one mechanically actuated clamp, the mechanically actuated clamp responsive to the position of the horizontal displacement system.

5. A system as in claim 1 wherein the one-way clamping and downstream pressure system includes at least one hydraulic cylinder operatively attached to the one-way clamping and downstream pressure system for applying downstream pressure.

6. A system as in claim 1 wherein the one-way clamping and downstream pressure system is simply a one-way clamping system. Such a system relies on the compression of the plurality of boards, locked into place between the downstream braking system and the on-way clamping system, and the energy developed within the compressed plurality of boards to provide the required inter-joint pressures.

7. A system for maintaining a high inter-joint pressure across a plurality of glued boards being continuously assembled on a deck, comprising a horizontal displacement system that provides downstream pressure system for advancing the glued boards across the deck, a braking system downstream of the downstream pressure system, and a one-way clamping system operatively connected to the deck for opposing the upstream movement, a downstream pressure system that provides the required downstream pressure when the horizontal displacement system is disengaged from the glued boards.
